(19) United States
(12) Patent Application Publication
(10) Pub. No.: US 2025/0246109 A1
(43) Pub. Date: Jul. 31, 2025

(54) DISPLAY-BASED USER ILLUMINATION SYSTEM

(71) Applicant: LENOVO (SINGAPORE) PTE. LTD., SINGAPORE (SG)

(72) Inventors: Joel Collins, Raleigh, NC (US); Nathan Peterson, Oxford, NC (US); Brian Lee, Raleigh, NC (US); John M. Petersen, Wake Forest, NC (US); Gary D. Cudak, Raleigh, NC (US); Alicia D. Jackson, Durham, NC (US)

(21) Appl. No.: 18/425,158

(22) Filed: Jan. 29, 2024

(51) Int. Cl. G09G 3/20

(52) U.S. Cl. CPC G09G 3/20; G09G 2320/0626; G09G 2320/0666; G09G 2340/04; G09G 2354/00

(57) ABSTRACT

A display-based user illumination system includes a memory that is configured to store program instructions and one or more processors operably connected to the memory. The program instructions are executable by the one or more processors to control a display device to display content to a user of the display device on a first area of a display screen of the display device. The program instructions are executable by the one or more processors to control the display device to provide an edge light along a different, second area of the display screen by emitting a constant light from the second area for an extended period of time to illuminate the user of the display device.

### FIELD

The present disclosure generally relates to electronic display devices, such as display devices that can be used for video conferences, video recording, and video streaming.

### BACKGROUND OF THE INVENTION

Computer cameras can be used for generating image data for video conferencing, video livestreaming, video recording, and capturing still images of one or more users or other subjects located in a field of view of the camera. One of the most challenging situations for computer cameras is low-light environments. Low-light environments may cause poor image quality. For example, in low and/or uneven light environments, the user of the computer may have a poorly lit face as depicted in the image data. The user's face may appear dim, may have shadows, and/or may have features that are difficult to discern to an observer. Post-capture processing of the image data may be insufficient to achieve an acceptable image quality.

Some computer users set up external lights near the camera to illuminate the users' faces or other subjects in the field of view. For example, some users set up ring lights above and/or behind the camera. Although external lights can improve the image quality, the lights are separate and discrete from the computer system. Incorporating external lights requires additional cost and time to set up. Furthermore, the external lights may not be as mobile as some computers, such as notebook and tablet computers. For example, external lights may be too large and cumbersome for a user to routinely disassemble and transport. If the user travels on a trip, the user may pack a notebook computer without bringing any external lights, so the user may experience degraded illumination on video calls during the trip. A need remains for enhancing the illumination of one or more subjects within a field of view of a computer camera for improved image quality without using lights external to the computer.

### SUMMARY

In accordance with an example or aspect, a display-based illumination system is provided that includes a memory and one or more processors that are operably connected to the memory. The memory is configured to stored program instructions. The program instructions are executable by the one or more processors to control a display device to display content to a user of the display device on a first area of a display screen of the display device. The program instructions are executable by the one or more processors to control the display device to provide an edge light along a different, second area of the display screen by emitting a constant light from the second area for an extended period of time to illuminate the user of the display device.

Optionally, the one or more processors may control the display device to display the content on the first area of the display screen and to provide the edge light along the second area of the display screen during an illumination mode of operation. The one or more processors may switch the display device between the illumination mode and a normal mode of operation in which the display device displays the content to the user on both the first and second areas of the display screen without providing the edge light. The one or more processors may control the display device to scale down a graphical user interface that is displayed on the display screen when switching from the normal mode to the illumination mode so that the graphical user interface is confined to the first area of the display screen in the illumination mode. The one or more processors may control the display device to restrict a cursor, for selectively interacting with the content displayed on the display screen, to the first area of the display screen in the illumination mode. Optionally, the one or more processors may switch the display device from the normal mode to the illumination mode in response to receiving a command message generated by a user input device configured to be operated by the user. Optionally, the one or more processors may switch the display device from the normal mode to the illumination mode in response to detecting a request to initiate at least one of a video conference, a video recording, or a video stream that is associated with the display device. Optionally, the one or more processors may analyze image data depicting the user. The image data is generated by a camera associated with the display device. The one or more processors may switch the display device from the normal mode to the illumination mode in response to determining that the user is in a low light condition based on the image data. The one or more processors may determine that the user is in the low light condition based on a value of a brightness of at least a portion of a face of the user in the image data being below a designated threshold value.

Optionally, the one or more processors may control the display device to provide the edge light along a border of the display screen that fully surrounds the first area. Optionally, the one or more processors may control the display device to provide the edge light along at least one edge of the display screen without fully surrounding the first area. The one or more processors may analyze image data depicting a face of the user. The image data generated by a camera is associated with the display device. The one or more processors may select the at least one edge of the display screen along which to provide the edge light based on the image data. The one or more processors may determine a low light region of the face of the user as depicted in the image data, and may select the at least one edge of the display screen along which to provide the edge light for a location of the edge light to correspond to the low light region of the face of the user. The one or more processors may receive a command message generated by a user input device configured to be operated by the user, and may control the display device to modify at least one of (i) a size of the second area of the display screen that provides the edge light, (ii) a brightness of the edge light, or (iii) a color temperature of the edge light, based on the command message.

In accordance with an example or aspect, a method of illuminating a user of a display device is provided. The method includes controlling a display device to display content to a user of the display device on a first area of a display screen of the display device. The method includes controlling the display device to provide an edge light along a different, second area of the display screen by emitting a constant light from the second area for an extended period of time to illuminate the user of the display device.

Optionally, the display device is controlled to display the content to the user on the first area of the display screen and to provide the edge light on the second area of the display screen during an illumination mode of operation of the display device. The method may include switching the display device between the illumination mode and a normal mode of operation in which the display device displays the content to the user on both the first and second areas of the display screen without providing the edge light. The method may include scaling down a graphical user interface that is displayed on the display screen when switching from the normal mode of operation to the illumination mode of operation so that the graphical user interface is confined to the first area of the display screen when in the illumination mode. Optionally, the method may include analyzing image data depicting the user. The image data is generated by a camera associated with the display device. The method may include determining that the user is in a low light condition based on the image data, and switching the display device from the normal mode to the illumination mode in response to determining that the user is in the low light condition.

Optionally, controlling the display device to provide the edge light along the second area may include positioning the edge light to fully surround the first area of the display screen. Optionally, the method may include receiving a command message generated by a user input device configured to be operated by the user, and controlling the display device to modify at least one of (i) a size of the second area of the display screen that provides the edge light, (ii) a brightness of the edge light, or (iii) a color temperature of the edge light based on the command message.

In accordance with an example or aspect, a computer program product is provided that includes a non-transitory computer readable storage medium. The non-transitory computer readable storage medium includes computer executable code configured to be executed by one or more processors to control a display device to display content to a user of the display device on a first area of a display screen of the display device. The computer executable code is configured to be executed by the one or more processors to control the display device to provide an edge light along a different, second area of the display screen by emitting a constant light from the second area for an extended period of time to illuminate the user of the display device.

### BRIEF DESCRIPTION OF THE DRAWINGS

FIG. 1 illustrates a computer device that incorporates a display-based user illumination system according to an embodiment.

FIG. 2 illustrates the computer device of FIG. 1 with a display device of the computer device in a normal mode of operation.

FIG. 3 is a block diagram of the illumination system according to an embodiment.

FIG. 4 illustrates a settings graphical user interface (GUI) depicting user-configurable settings for the illumination system.

FIGS. 5A-5D illustrate different edge light configurations according to an embodiment of the illumination system.

FIG. 6 is a flow chart of a method of illuminating a user of a display device according to an embodiment.

### DETAILED DESCRIPTION

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

The embodiments described herein provide a display-based user illumination system, also referred to herein as an illumination system. The illumination system selectively repurposes a portion of a display screen as a light source instead of as a content display. For example, typically the entire display screen of a display device is used to display content to one or more users that are observing the display screen. Reference herein is made to a user in the singular, although it is recognized that multiple users may be positioned to observe and use the same display device. The content may be various forms of graphical content, such as media (e.g., videos, movies, images, Internet webpages, online newspapers, and the like), word processing documents, spreadsheets, presentations, and the like. The content is typically rendered by the display device and presented to the user through graphical user interfaces (GUIs). The GUIs allow the user to interact with the computer device and control the content that is presented on the display screen. For example, a user may manipulate a user input device such as a computer mouse or touchpad to move a digital cursor along the display screen for interacting with the GUIs.

Some display devices have associated cameras that are positioned to have a field of view that encompasses the user of the display device. For example, the user of a display device may be located within a designated proximity of the display device and positioned to observe the display screen of the display device. A typical example is a person that is operating a computer device and looking at the display of the computer device. In an example, the user may be sitting or standing at a desk on which the computer device is set. In another example, the computer device may be mobile, such as a tablet computer or a smartphone, and the user may be holding the computer device. In another example, the display device may be a television, a video conferencing hub station, or another non-traditional computer device. In that case, the user of the display device may be people or other subjects in the same room as the display device that are able to observe the display screen of the display device and are within a designated proximity of the display device. The camera that is associated with the display device may be integrated with the display device during the manufacturing of the display device. For example, some laptop (e.g., notebook) computers have integrated cameras within the bezel that surrounds the display screen. Alternatively, some cameras are discrete from display devices and include coupling mechanisms, such as clips, for removably mounting to different display devices. These discrete cameras may electrically connect to a computer device via a wired or wireless connection to communicate image data generated by the camera to the computer device.

The camera associated with the display device may be used to generate image data depicting the user of the display device. For example, the camera may be positioned to have a field of view that generally faces in the same direction as the display screen. The camera generates the image data by using an optical sensor to capture light reflected off the user and other objects of the surrounding environment within the field of view of the camera. The camera may be active to generate image data depicting the user for recording video, generating still images, and/or streaming video via a network (e.g., the Internet) to other computer devices. For example, the user may activate the camera during a video conference (e.g., video call) to allow other participants of the video conference to view the user. During the video conference, the image data generated by the camera may be streamed or otherwise transmitted to the computer devices of the other participants.

As described above, sometimes the user may be in a low-light environment or an uneven lighting environment which results in poor image quality of the image data generated by the camera. For example, the user may be in an uneven lighting environment if part of the user's face is in a shadow. The poor image quality is undesirable because an observer viewing the image data, such as watching a recorded video or participating in a video conference with the user, may not be able to view fine details of the user's face. The observer may not be able to interpret facial cues from the user, such as reading the user's lips, which may detract from the communication experience. The illumination system described herein resolves the issue of poor image quality due to low and/or uneven lighting by selectively allocating a portion of the display screen as a light source to illuminate the user that uses the display device.

When activated, the illumination system restricts content display to a first area of the display screen and utilizes a different, second area of the display screen to provide an edge light. The edge light illuminates the user's face, thereby improving image quality of the image data generated by the associated camera. The edge light may be a constant light, meaning that the light is continuously emitted while the edge light is activated without flashing or any other type of sequencing effects (e.g., cascading, chasing, pulsing, etc.). The edge light may provide constant lighting, similar to an external lamp or other lighting device, for an extended period of time. For example, the illumination system may provide the edge light during the duration of a video conference, the duration of a video recording, and/or until a user selectively deactivates the edge light. The light emitted by the edge light may be white, although the specific wavelength and other properties of the white light may be configurable by the user and/or a controller of the illumination system. For example, the user and/or the automated controller may control the color temperature of the light that is emitted, such as to select between a warm, yellowish light and a cool, bluish light.

References herein to “computer device”, unless specified, shall mean any of various types of hardware devices that perform processing operations, such as personal computers, standalone video conference hub devices, computer workstations, and the like. The personal computers may include laptop (e.g., notebook) computers, desktop computers, tablet computers, smartphone computers, wearable computers, and the like.

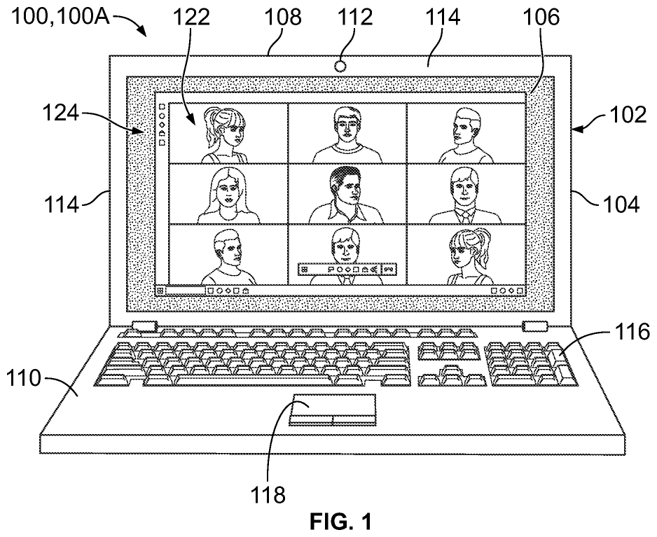

FIG. 1 illustrates a computer device 100 that incorporates a display-based user illumination system 102 according to an embodiment. The computer device 100 in FIG. 1 may be a laptop computer 100a. The illumination system 102 described herein is not limited to laptop computers. For example, the illumination system 102 may be incorporated in various different types of computer devices, such as desktop computers, tablet computers, smartphones, standalone video conference hub devices, computer workstations, and the like. The term “computer devices”, unless specified, shall mean any of various types of hardware devices that perform processing operations, such as the devices listed above. The laptop computer 100a has a display device 104 that includes a display screen 106. The display screen 106 is integrated on a cover panel 108 that is pivotably connected to a base 110 of the laptop computer 100a. The base 110 may contain a keyboard 116, a touchpad 118, and computing hardware and circuitry. The laptop computer 100a may include a camera 112. The camera 112 in an example is integrated with the cover panel 108. For example, the camera 112 may be embedded within a bezel 114 of the cover panel 108 that surrounds the display screen 106. In another example, the camera 112 may be discrete from the laptop computer 100a and removably coupled to the cover panel 108.

The display device 104 may include the display screen 106, light sources that illuminate the display screen 106, a graphics processing unit (GPU), and associated circuitry. For example, the display device 104 may include a backlight that has an array of light emitters. The light emitter(s) may be light emitting diodes (LEDs) or the like. The display screen 106 may be a liquid crystal display (LCD) or the like. The GPU may control the light emitters to illuminate the display screen 106.

The illumination system 102 includes one or more processors. The one or more processors may execute program instructions (e.g., software) to control the display device 104 to display content to a user of the laptop computer 100a on a first area 122 of the display screen 106. The content may be one or more GUIs. The GUIs may provide graphical content such as Internet webpages, multimedia controls, videos, still images, word processing documents, spreadsheets, presentations, desktop background images showing icons for various programs, and/or the like. In the illustrated example, the content may include video streams showing remote participants of a video conference. The first area 122 of the display screen 106 is also referred to herein as a content display area 122.

In an embodiment, the one or more processors of the illumination system 102 may execute program instructions (e.g., software) to control the display device 104 to provide an edge light along a different, second area 124 of the display screen 106. The display device 104 may provide the edge light by emitting a constant light from the second area 124 for an extended period of time. The second area 124 is referred to herein as an edge light area 124. The edge light may be provided to illuminate the user of the laptop computer 100a. For example, the edge light may illuminate the user's face which brightens the user's face and improves image quality of image data generated by the camera 112 while the edge light is active (relative to the image quality of image data generate by the camera 112 while the edge light is inactive).

As illustrated, the edge light 124 is provided along a portion of the display screen 106 that is designed and typically used for displaying content. For example, the edge light area 124 of the display screen 106 is seamlessly connected to the content display area 122. Both of the areas 124, 126 are within and surrounded by the bezel 114. In an embodiment, the one or more processors of the illumination system 102 provide the edge light by selectively repurposing a portion of the display screen 106 from displaying content to emitting a constant light to illuminate the user. As such, the light emitters that create the edge light may be part of the same array of light emitters as the light emitters that illuminate the display screen 106 to provide the content (e.g., graphical content) to the user. In an example, the one or more processors may reallocate some of the light emitters of the display backlight from providing content to providing the constant white light of the edge light.

The edge light area 124 in the illustrated embodiment fully surrounds the content display area 122. For example, the edge light area 124 is a rectangular border that is disposed between the content display area 122 and the bezel 114 of the cover panel 108 that surrounds the display screen 106. The edge light in this configuration may evenly illuminate the user. For example, the light is emitted from a top strip of the edge light area 124, a bottom strip of the edge light area 124, a left strip of the edge light area 124, and a right strip of the edge light area 124. The emitted light may illuminate different portions of the user's head and face, reducing the likelihood of shadows and other low light areas along the user's face. The edge light area 124 may have a different shape and/or location along the display screen 106 in other embodiments and/or use applications. In an example, the one or more processors may select the location of the edge light area 124 along the display screen 106 based on an analysis of lighting in the surrounding environment of the display device 104. Furthermore, the location, shape, and/or size of the edge light area 124 may be selectively configurable by the user in program settings of the illumination system 102.

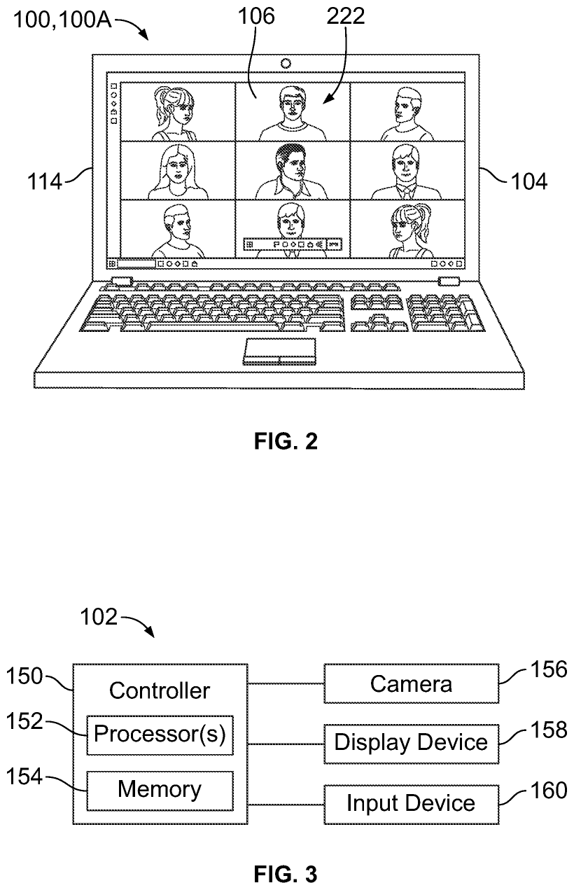

The one or more processors of the illumination system 102 may switch between an illumination mode of operation for the display device 104 and a normal mode of operation. The illumination mode is shown in FIG. 1. In the illumination mode, part of the display screen 106 is allocated as the content display area 122 and another part is allocated as the edge light area 124. In the normal mode, the one or more processors may utilize the entire illuminated surface area of the display screen for displaying content to a user. FIG. 2 illustrates the computer device 100 of FIG. 1 with the display device 104 in the normal mode of operation. In the normal mode, a content display area 222 occupies an entire surface area of the display screen 106 (e.g., the area bounded by the bezel 114). The display device 104 does not provide the edge light in the normal mode. The one or more processors may switch between the two modes. The one or more processors may switch modes automatically based on one or more designated triggering events or on demand in response to receiving a user-generated command signal. The one or more processors switch modes by effectively repurposing different areas of the display screen 106. For example, the part of the display screen 106 utilized to provide the edge light in the illumination mode (e.g., the edge light area 124 in FIG. 1) is part of the content display area 222 in the normal mode as shown in FIG. 2. As such, the light emitters that illuminate the portion of the display screen 106 are controlled to switch from generating the constant white light of the edge light to generating display content with the rest of the light emitters of the display device 104. The content display area 222 in the normal mode is larger than the content display area 122 (shown in FIG. 1) in the illumination mode.

In an example, the one or more processors may control the display device 104 to scale down at least one GUI that is displayed on the display screen 106 when switching from the normal mode to the illumination mode. For example, as shown in FIGS. 1 and 2, the content display area 222 in the normal mode is larger than the content display area 122 in the illumination mode. During the transition from the normal mode to the illumination mode, the one or more processors may uniformly shrink or scale down the content that is being displayed (e.g., the one or more GUIs) by the display device to a size that fits within the smaller content display area 122. For example, if a GUI is displayed at a scale of 100% in the content display area 222 during the normal mode, the one or more processors may scale down the GUI to 80% when transitioning to the illumination mode. The extent of scaling may be based on the size of the edge light area 124 (e.g., the amount by which the normal mode content display area 222 shrinks to provide the illumination mode content display area 122).

When in the illumination mode, the one or more processors may restrict all of the content display to the confines of the content display area 122. For example, the one or more processors may control the display device to establish virtual “walls” at the edges of the content display area 122. Due to the virtual walls, the user is not allowed or able to move a cursor or any GUI windows beyond the content display area 122 into the edge light area 124. The cursor is an icon that is shown on the GUI and is provided to allow the user to selectively interact with the content that is displayed on the display screen 106. The one or more processors may restrict the cursor to the content display area 122 in the illumination mode of operation.

FIG. 3 is a block diagram of the illumination system 102 according to an embodiment. The illumination system 102 includes a controller 150 that has one or more processors 152 and at least one tangible and non-transitory computer-readable storage medium (e.g., data storage device), referred to herein as memory 154. The one or more processors 152 perform some or all of the operations of the illumination system 100 described herein. The memory 154 may store program instructions (e.g., software) that are executed by the one or more processors 152 to perform the operations of the illumination system 102 described herein. For example, the program instructions stored in the memory 154 may be executable by the one or more processors 152 to control the display device 104 to provide the edge light and to switch the illumination mode and the normal mode.

The one or more processors 152 represent hardware circuitry, such as one or more microprocessors, integrated circuits, microcontrollers, field programmable gate arrays, etc.). In a first example, the illumination system 102 has only a single processor 152. In a second example, the illumination system 102 has multiple processors 152 integrated within a single computer device (e.g., the computer device 100a). In a third example, the illumination system 102 has multiple processors 152 that are integrated into different, discrete computer devices (e.g., personal computers, servers, cloud storage and/or computing devices, etc.), and the processors 152 may be communicatively connected to perform the operations of the illumination system 102 described herein. For example, a first subset of the processors 152 may perform a first function of the illumination system 102, and a second subset of the processors 152 may perform a second function of the illumination system 102 based on communication with the first subset. For ease of description, references herein are made to the controller 150, which includes the one or more processors 152.

The illumination system 102 may include additional components such as a camera 156, a display device 158, and a user input device 160. The additional components may be operatively or operably (e.g., communicatively) connected to the controller 150 via wired and/or wireless communication links to permit the transmission of data, commands, and other information in the form of signals. For example, the controller 150 may generate control signals that are transmitted to the display device 158 to control operation of the display device 158. The display device 158 may be the display device 104 of the laptop computer 100a shown in FIGS. 1 and 2. The illumination system 102 may have additional components that are not shown in FIG. 3. In an alternative embodiment, the illumination system 102 may lack one or more of the additional components that are shown in FIG. 3.

The camera 156 is an optical sensor that generates (e.g., captures) image data representative of subject matter within a field of view of the camera 156 at the time that the image data is generated. The image data is generated based on light that impinges on the optical sensor. The image data may be a series of image frames generated over time. The series of image frames may be a video. The camera 156 is associated with the computer device 100. The camera 106 may be generally fixed in place during use. For example, the camera 156 may be mounted on a desk next to a computer device 100, may be removably mounted to the computer device 100, and/or may be an integral component of the computer device 100. In an example, the camera 156 can be a webcam that is oriented to face toward the user that is operating the computer device 100 and viewing the display device 158. The image data generated by the camera 156 may be received and analyzed by the controller 150. The controller 150 may analyze the image data to determine light conditions in the ambient environment, as described herein. The controller 150 may use the light conditions that are determined to control the display device 158 to provide the edge light. Some image data generated by the camera 156 may be remotely communicated to other computer devices and/or servers, such as during a video conference.

The display device 158 may be the display device 104 shown in FIGS. 1 and 2. For example, the display device 158 may be an integral component of a computer device 100, such as the laptop 100a, a tablet computer, smartphone, a television, a video conference hub device, or the like. Alternatively, the display device 158 may be a peripheral component that is communicatively connected to a computer device 100. For example, the display device 158 may be a monitor that is connected to a desktop computer or workstation. The display device 158 includes a display screen. The display screen may be an LCD screen or the like. The display screen is illuminated by an array of light emitting elements of the display device. The light emitting elements may be controlled by a GPU. The light emitting elements may be part of a backlight that illuminates the LCD screen. The display device 158 is controlled by the controller 150 to selectively provide the edge light (e.g., to switch between the illumination mode and the normal mode of operation). For example, the controller 150 may generate control signals that are conveyed via a wired or wireless communication path to the GPU of the display device 158 to control the display device 158. The display device 158 may be powered by a power source, such as an electrical power circuit in a building.

The user input device 160 is designed to receive user inputs (e.g., selections) from a user that interacts with the illumination system 102. The input device 160 may include a touch sensitive screen or pad, a mouse, a keyboard, a joystick, a switch, physical buttons, and/or the like. The input device 160 may be integrated into a computer device 100, such as the laptop computer 100a shown in FIGS. 1 and 2. For example, the keyboard 116 and the touchpad 118 of the laptop computer 100a are examples of input devices 160. The user may actuate the input device 160 to control at least some operations of the illumination system 100. For example, the user may actuate the input device 160 to activate the illumination mode which provides the edge light, to switch back to the normal mode, to open or activate a video conferencing program or application which automatically causes the controller 150 to switch to the illumination mode in low light conditions, and/or to change or select settings of the edge light.

In an example, the controller 150 (e.g., the one or more processors 152) may receive a command message that is generated by the user input device 160. The command message may include one or more control signals. The user may operate the input device 160 to generate the command message. In response to receiving the command message, the controller 150 may switch the display device 158 from the normal mode to the illumination mode, to initiate the edge light. For example, the user may use the input device 160 to selectively activate the edge light when the user desires additional lighting.

In another example, the user may use the input device 160 to select or adjust settings of the illumination system 102. The settings may include the size of the edge light, the shape of the edge light, the location of the edge light, the brightness of the edge light, the color temperature of the edge light, default settings, and/or the like.

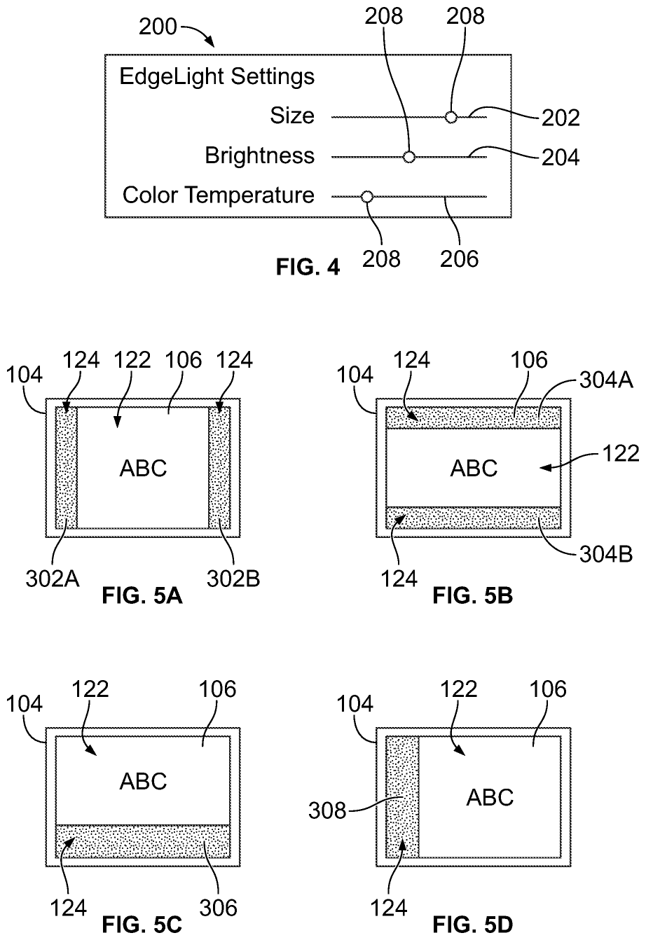

FIG. 4 illustrates a settings GUI 200 depicting user-configurable settings for the illumination system 100. The controller 150 may control the display device 158 to display the settings GUI 200 on the display screen. For example, the controller 150 may generate the settings GUI 200 on the display screen in response to receiving a user command message from the user input device 160 to open program settings. The settings GUI 200 in the illustrated embodiment includes sliding scales 202, 204, 206 for adjusting three different settings of the edge light to be displayed when in the illumination mode. For example, a first sliding scale 202 controls the size of the edge light area 124 on the display screen (and inversely also controls the size of the content display area 122). The second sliding scale 204 controls the brightness of the edge light, meaning the brightness of the constant lighting that is emitted from the edge light area 124 when in the illumination mode. The third sliding scale 206 controls the color temperature of the edge light. The scale may transition between cool bluish light and warm yellowish light. The third scale 206 may be a Kelvin temperature scale. The user can use the input device 160 to modify these three settings as desired by moving the locations of the respective indicators 208 along the lengths of the scales 202, 204, 206. For example, the controller 150 may receive a command message generated by the user input device 160 as manipulated by the user. With reference to FIG. 1, the command message may instruct the controller 150 to control the display device 158 to modify a size of the edge light area 124 of the display screen 106, a brightness of the edge light, and/or a color temperature of the edge light. The settings GUI 200 may provide additional and/or different user-configurable settings in other embodiments.

The illumination system 102 may include default settings that control when the controller 150 automatically switches between the illumination mode and the normal mode. One example setting may instruct the controller 150 to automatically turn on the edge light (e.g., switch to the illumination mode) in response to detecting a request to initiate at least one of a video conference, a video recording, or a video stream that is associated with the display device. For example, upon the user attempting to join a video conference, attempting to commence a video recording, or attempting to live stream using the camera 156, the controller 150 may automatically switch to the illumination mode and provide the edge light according to a default setting. At the end of the video conference, the video recording, and/or the live streaming event, the controller 150 may automatically switch back to the normal mode. Alternatively, a setting may instruct the controller 150 to only switch to the illumination mode in response to receiving a command message from the user input device 160. In this setting, the user determines when the edge light is desired.

In an embodiment, the controller 150 may automatically switch from the normal mode to the illumination mode based on an analysis of image data generated by the camera 156. For example, the camera 156 may be activated by the user by initiating a video conference, video recording, or video stream, by selecting a virtual button to turn on the camera 156, and/or by selecting to activate a program for video conferencing, video recording, or video streaming. The active camera 156 generates image data depicting the field of view. The field of view may encompass the ambient or surrounding environment of the display device 158. For example, the image data may depict at least a portion of the user that is observing the display device 158, such as the user's face.

In an embodiment, the controller 150 may receive and analyze image data generated by the camera 156. The controller 150 may determine that the user is in a low light condition based on the analysis of the image data. The low light condition may refer to a condition in which the illumination of the user (e.g., the user's face) does not meet a threshold brightness and/or uniformity. For example, the user may be in the low light condition when the user's face is dimly illuminated and/or a substantial portion of the user's face is cast in shadow. The controller 150 may determine the low light condition by comparing characteristics or parameters of the pixels of image data to objective standards. In an example, if the value of a brightness of at least a portion of the user's face as depicted in the image data is below a designated threshold value, the controller 150 may determine that the user is in a low light condition. The value of the brightness may be determined based on an intensity of the light. The controller 150 may aggregate the parameters of a group of pixels to determine the brightness value of a section of the user's face. The controller 150 may also compare the brightness values of different sections of the user's face to determine if part of the user's face is cast in a shadow. If so, the controller 150 may determine that the user is in a low light condition, even if the brighter part of the user's face satisfies the designated threshold value. In response to determining that the user is in the low light condition, the controller 150 may automatically switch the display device 158 from the normal mode to the illumination mode, thereby providing the edge light to illuminate the user's face and improve the image quality.

In another example, the controller 150 may include or be connected to a machine learning algorithm. The machine learning algorithm may be designed, such as trained, to analyze images that are input to the machine learning algorithm and generate an output regarding which input images reflect a low light condition and which other input images do not reflect a low light condition (e.g., have sufficient light to avoid activating the edge light). The machine learning algorithm may receive images generated by the camera 156 as the input images. The machine learning algorithm may be an artificial neural network.

In an example, after switching to the illumination mode in response to determining that the user is in the low light condition, the controller 156 may maintain the display device 158 in the illumination mode until the camera 156 is deactivated and/or the controller 156 determines that the user is no longer in the low light condition. For example, the controller 156 and/or the machine learning algorithm may continue to periodically analyze image data generated by the camera 156 even when in the illumination mode. If newly-analyzed image data indicates that the user's face is sufficiently bright and evenly illuminated that the user is no longer in the low light condition, then the controller 150 may control the display device 158 to switch back to the normal mode.

The examples above describe the controller 150 controlling the display device 158 to automatically switch between the illumination mode and the normal mode in response to certain triggering events. Optionally, the illumination system 102 may have a selected default setting that the controller 150 does not automatically switch the display device 158 between modes without user confirmation/approval. As such, in the examples above, in response to determining that the display device 158 should be switched to a different mode, the controller 150 may generate a text-based notification message that is displayed on the display device 158 and prompts the user to approve switching the operating mode of the display device 158. In an example, in response to determining that the user is in a low light condition, the controller 150 generates a notification message that is displayed on the display screen by the display device 158. The notification message may inform the user that the user's face is insufficiently or poorly illuminated and may suggest that the user approve the switch to the illumination mode to provide the edge light.

The illumination system 102 provides the edge light along a rectangular border of the display screen 106 in the example shown in FIG. 1. Although the rectangular border is one example, the edge light may have other shapes and/or locations along the display screen 106. FIGS. 5A-5D illustrate different edge light configurations according to an embodiment of the illumination system 102. The edge light configurations shown in FIGS. 5A-5D are alternatives to the configuration shown in FIG. 1. The configurations (e.g., the shapes and/or locations of the edge light) may be selected by the user in settings using the input device 160 and/or determined by the controller 150. Each example shows the display device 104 of FIG. 1 in the illumination mode. In each example, a first portion of the display screen 106 is the content display area 122 (represented by the letters “ABC” in FIGS. 5A-5D) and the remainder of the display screen 106 is the edge light area 124. In each of the illustrated examples, the controller 150 controls the display device 158 to provide the edge light along at least one edge of the display screen 106 without fully surrounding the content display area 122.

In FIG. 5A, the edge light area 124 includes two vertical strips 302A, 302B on the left and right sides of the content display area 122. In FIG. 5B, the edge light area 124 includes two horizontal strips 304A, 304B on the top and bottom of the content display area 122. In FIG. 5C, the edge light area 124 includes a single horizontal strip 306 on the bottom of the content display area 122. In FIG. 5D, the edge light area 124 includes a single vertical strip 308 on the left side of the content display area 122. These configurations are examples, and the illumination system 102 may provide additional example configurations that are not shown in FIGS. 1 and 5A-5D. For example, the illumination system 102 may provide the edge light to have a shape that is not a rectangular border or a rectangular strip. In various examples, the edge light area 124 may be a U-shape, a C-shape, a circular shape, an oval shape, or the like.

In an example, the controller 150 may select the edge light configuration for the display device 158 based on an analysis of the image data generated by the camera 156. For example, the controller 150 may analyze the illumination of the user's face as depicted in the image data. The controller 150 may select the shape and/or location of the edge light area 124 based on the image analysis. For example, the controller 150 may select which edge or edges of the display screen 106 to provide the edge light in order to compensate for uneven illumination of the user's face. The controller 150 may analyze the image data, as described above with reference to the low light condition, and may determine a low light region of the user's face. The low light region may be a portion of the user's face that is cast in shadow. The controller 150 may determine the low light region by determining that the contrast in brightness of different regions of the user's face exceeds a contrast threshold. Alternatively, the controller 150 may include a machine learning algorithm that receives the image data as input images and generates an output determination of whether the user's face has a low light region. The machine learning algorithm may be trained to identify low light regions in users' faces.

In response to determining that the image data does show a low light region of the user's face, the controller 150 may select the edge light configuration based on the location and/or identity of the low light region. For example, the controller 150 may select the edge or edges of the display screen 106 along which to provide the edge light for the edge light area 124 to correspond to the low light region of the user's face. As an example, in response to determining that the left side of the user's face represents a low light region, the controller 150 may select the configuration shown in FIG. 5D for the edge light area 124 to be located along the left edge of the display screen 106. In effect, the illumination system 102 will illuminate the low light region of the user's face more than the brighter areas of the user's face, providing a more even and uniformly lit user face for the camera 156 to capture in image data.

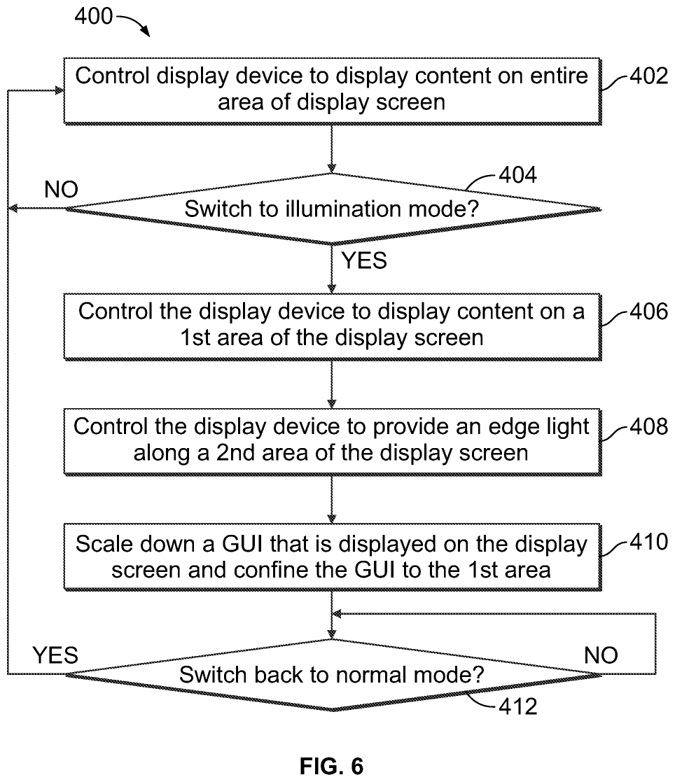

FIG. 6 is a flow chart 400 of a method of illuminating a user of a display device according to an embodiment. The method may be performed entirely or in part by the controller 150 (e.g., the one or more processors 152) of the illumination system 102. The method optionally may include at least one additional step than shown, at least one fewer step than shown, and/or at least one different step than shown.

At step 402, a display device 104 is controlled to display content to a user on an entire area of the display screen 106 during a normal mode of operation. At step 404, a determination is made whether or not to switch the display device 104 to an illumination mode of operation. The determination may be made by the user generating a command message via a user input device 160. Alternatively, the determination may be based on automatically detecting the occurrence of one or more designated triggering events (e.g., stimuli). For example, the method may include analyzing image data depicting the user. The image data is generated by a camera 156 that is associated with the display device 104. The method may include determining that the user is in a low light condition based on the image data. Determining that the user is in the low light condition may prompt the method to switch to the illumination mode. Another triggering event that causes the method to switch to the illumination mode may be the activation of the camera 156, receiving a request to initiate a video conference, a video recording, or a video stream, or the like.

Upon determining at step 404 to switch to the illumination mode, the method proceeds to step 406. At step 406, the display device 104 is controlled to display content to a user of the display device 104 on a first (e.g., content display) area 122 of the display screen 106. At step 408, the display device 104 is controlled to provide an edge light along a different, second (e.g., edge light) area 124 of the display screen 106. The display device 104 may provide the edge light by emitting a constant light from the edge light area 124 for an extended period of time to illuminate the user of the display device 104. In an example, controlling the display device 104 to provide the edge light may include positioning the edge light area 124 to fully surround the content display area 122 of the display screen 106.

At step 410, the method may include scaling down a graphical user interface (GUI) that is displayed on the display screen 106 when switching from the normal mode to the illumination mode so that the graphical user interface is confined to the content display area 122 of the display screen 106 in the illumination mode. In addition, a cursor representing an indicator controlled by a mouse, touchpad, or other user input device 160 may also be restricted to the content display area 122.

At step 412, it is determined whether or not to switch from the illumination mode to the normal mode. The determination may be based on a command message received from the user input device 160 and/or a detection of a designated triggering event that causes the controller 150 to automatically revert to the normal mode. The triggering event may be deactivation of the camera 156, termination of a video conference, video recording event, or video streaming event, detection of sufficient ambient lighting and illumination of the user's face to obviate the need for the edge light, and/or the like. If it is determined to switch back to the normal mode, the method may return to step 402. The graphical user interface may be scaled up in size during the transition from the illumination mode to the normal mode.

Optionally, the method may include additional steps, such as receiving a command message generated by the user input device 160, where the command message relates to user-configurable settings. The method may include controlling the display device 104 to modify at least one of (i) a size of the edge light area 124 of the display screen 106, (ii) a brightness of the edge light, or (iii) a color temperature of the edge light based on the command message.

### Closing Statements

As will be appreciated by one skilled in the art, various aspects may be embodied as a system, method or computer (device) program product. Accordingly, aspects may take the form of an entirely hardware embodiment or an embodiment including hardware and software that may all generally be referred to herein as a “circuit,” “module” or “system.” Furthermore, aspects may take the form of a computer (device) program product embodied in one or more computer (device) readable storage medium(s) having computer (device) readable program code embodied thereon.

Any combination of one or more non-signal computer (device) readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a dynamic random access memory (DRAM), a read-only memory (ROM), an erasable programmable read-only memory (EPROM or Flash memory), a portable compact disc read-only memory (CD-ROM), an optical storage device, a magnetic storage device, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of network, including a local area network (LAN) or a wide area network (WAN), or the connection may be made through other devices (for example, through the Internet using an Internet Service Provider) or through a hard wire connection, such as over a USB connection. For example, a server having a first processor, a network interface, and a storage device for storing code may store the program code for carrying out the operations and provide this code through its network interface via a network to a second device having a second processor for execution of the code on the second device.

Aspects are described herein with reference to the Figures, which illustrate example methods, devices and program products according to various example embodiments. These program instructions may be provided to a processor of a general purpose computer, special purpose computer, or other programmable data processing device or information handling device to produce a machine, such that the instructions, which execute via a processor of the device implement the functions/acts specified.

The program instructions may also be stored in a device readable medium that can direct a device to function in a particular manner, such that the instructions stored in the device readable medium produce an article of manufacture including instructions which implement the function/act specified. The program instructions may also be loaded onto a device to cause a series of operational steps to be performed on the device to produce a device implemented process such that the instructions which execute on the device provide processes for implementing the functions/acts specified.

The units/modules/applications herein may include any processor-based or microprocessor-based system including systems using microcontrollers, reduced instruction set computers (RISC), complex instruction set computer (CISC), application specific integrated circuits (ASICs), field-programmable gate arrays (FPGAs), logic circuits, and any other circuit or processor capable of executing the functions described herein. Additionally, or alternatively, the units/modules/controllers herein may represent circuit modules that may be implemented as hardware with associated instructions (for example, software stored on a tangible and non-transitory computer readable storage medium, such as a computer hard drive, ROM, RAM, or the like) that perform the operations described herein. The above examples are exemplary only, and are thus not intended to limit in any way the definition and/or meaning of the term “controller.” The units/modules/applications herein may execute a set of instructions that are stored in one or more storage elements, in order to process data. The storage elements may also store data or other information as desired or needed. The storage element may be in the form of an information source or a physical memory element within the modules/controllers herein. The set of instructions may include various commands that instruct the modules/applications herein to perform specific operations such as the methods and processes of the various embodiments of the subject matter described herein. The set of instructions may be in the form of a software program. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to user commands, or in response to results of previous processing, or in response to a request made by another processing machine.

In one embodiment, the controller of the illumination system may have a local data collection system deployed that may use machine learning to enable derivation-based learning outcomes. The controller may learn from and make decisions on a set of data (including data provided by the various sensors), by making data-driven predictions and adapting according to the set of data. In embodiments, machine learning may involve performing a plurality of machine learning tasks by machine learning systems, such as supervised learning, unsupervised learning, and reinforcement learning. Supervised learning may include presenting a set of example inputs and desired outputs to the machine learning systems. Unsupervised learning may include the learning algorithm structuring its input by methods such as pattern detection and/or feature learning. Reinforcement learning may include the machine learning systems performing in a dynamic environment and then providing feedback about correct and incorrect decisions. In examples, machine learning may include a plurality of other tasks based on an output of the machine learning system. In examples, the tasks may be machine learning problems such as classification, regression, clustering, density estimation, dimensionality reduction, anomaly detection, and the like. In examples, machine learning may include a plurality of mathematical and statistical techniques. In examples, the many types of machine learning algorithms may include decision tree based learning, association rule learning, deep learning, artificial neural networks, genetic learning algorithms, inductive logic programming, SVMs, Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. In embodiments, certain machine learning algorithms may be used (e.g., for solving both constrained and unconstrained optimization problems that may be based on natural selection). In an example, the algorithm may be used to address problems of mixed integer programming, where some components restricted to being integer-valued. Algorithms and machine learning techniques and systems may be used in computational intelligence systems, computer vision, Natural Language Processing (NLP), recommender systems, reinforcement learning, building graphical models, and the like. In an example, machine learning may be used for vehicle performance and behavior analytics, and the like.

In one embodiment, the controller of the illumination system may include a policy engine that may apply one or more policies. These policies may be based at least in part on characteristics of a given item of equipment or environment. With respect to control policies, a neural network can receive input of a number of environmental and task-related parameters. These parameters may include an identification of a determined trip plan for a vehicle group, data from various sensors, and location and/or position data. The neural network can be trained to generate an output based on these inputs, with the output representing an action or sequence of actions that the vehicle group should take to accomplish the trip plan. During operation of one embodiment, a determination can occur by processing the inputs through the parameters of the neural network to generate a value at the output node designating that action as the desired action. This action may translate into a signal that causes the vehicle to operate. This may be accomplished via back-propagation, feed forward processes, closed loop feedback, or open loop feedback. Alternatively, rather than using backpropagation, the machine learning system of the controller may use evolution strategies techniques to tune various parameters of the artificial neural network. The controller may use neural network architectures with functions that may not always be solvable using backpropagation, for example functions that are non-convex. In one embodiment, the neural network has a set of parameters representing weights of its node connections. A number of copies of this network are generated and then different adjustments to the parameters are made, and simulations are done. Once the output from the various models are obtained, they may be evaluated on their performance using a determined success metric. The best model is selected, and the vehicle controller executes that plan to achieve the desired input data to mirror the predicted best outcome scenario. Additionally, the success metric may be a combination of the optimized outcomes, which may be weighed relative to each other.

It is to be understood that the subject matter described herein is not limited in its application to the details of construction and the arrangement of components set forth in the description herein or illustrated in the drawings hereof. The subject matter described herein is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. Further, in the following claims, the phrases “at least A or B”, “A and/or B”, and “one or more of A and B” (where “A” and “B” represent claim elements), are used to encompass i) A, ii) B or iii) both A and B.

It is to be understood that the above description is intended to be illustrative, and not restrictive. For example, the above-described embodiments (and/or aspects thereof) may be used in combination with each other. In addition, many modifications may be made to adapt a particular situation or material to the teachings herein without departing from its scope. While the dimensions, types of materials and coatings described herein are intended to define various parameters, they are by no means limiting and are illustrative in nature. Many other embodiments will be apparent to those of skill in the art upon reviewing the above description. The scope of the embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects or order of execution on their acts.

1. A display-based illumination system comprising:
a memory configured to store program instructions; and
one or more processors operably connected to the memory, wherein the program instructions are executable by the one or more processors to:
control a display device to display content to a user of the display device on a first area of a display screen of the display device;
control the display device to provide an edge light along a different, second area of the display screen by emitting a constant light from the second area for an extended period of time to illuminate the user of the display device; and
control the display device to restrict a cursor, for selectively interacting with the content displayed on the display screen, to the first area of the display screen by preventing the cursor from moving into the second area that provides the edge light.

2. The display-based illumination system of claim 1, wherein the one or more processors are configured to control the display device to display the content on the first area of the display screen, to provide the edge light along the second area of the display screen, and to restrict the cursor to the first area during an illumination mode of operation, and the one or more processors are configured to switch the display device between the illumination mode and a normal mode of operation in which the display device displays the content to the user on both the first and second areas of the display screen without providing the edge light.

3. The display-based illumination system of claim 2, wherein the one or more processors are configured to control the display device to scale down a graphical user interface that is displayed on the display screen when switching from the normal mode to the illumination mode so that the graphical user interface is confined to the first area of the display screen in the illumination mode.

4. The display-based illumination system of claim 2, wherein, in the illumination mode, the one or more processors are configured to allow the cursor to freely move within the first area of the display screen, for selectively interacting with the content displayed on the display screen, without entering the second area of the display screen.

5. The display-based illumination system of claim 2, wherein the one or more processors are configured to switch the display device from the normal mode to the illumination mode in response to receiving a command message generated by a user input device configured to be operated by the user.

6. The display-based illumination system of claim 2, wherein the one or more processors are configured to switch the display device from the normal mode to the illumination mode in response to detecting a request to initiate at least one of a video conference, a video recording, or a video stream that is associated with the display device.

7. The display-based illumination system claim 2, wherein the one or more processors are configured to:
analyze image data depicting the user, the image data generated by a camera associated with the display device; and
switch the display device from the normal mode to the illumination mode in response to determining that the user is in a low light condition based on the image data.

8. The display-based illumination system of claim 7, wherein the one or more processors are configured to determine that the user is in the low light condition based on a value of a brightness of at least a portion of a face of the user in the image data being below a designated threshold value.

9. The display-based illumination system of claim 1, wherein the one or more processors are configured to control the display device to provide the edge light along a border of the display screen that fully surrounds the first area.

10. The display-based illumination system of claim 1, wherein the one or more processors are configured to control the display device to provide the edge light along at least one edge of the display screen without fully surrounding the first area.

11. The display-based illumination system of claim 10, wherein the one or more processors are configured to:
analyze image data depicting a face of the user, the image data generated by a camera associated with the display device; and
select the at least one edge of the display screen along which to provide the edge light based on the image data.

12. The display-based illumination system of claim 11, wherein the one or more processors are configured to:
determine a low light region of the face of the user as depicted in the image data; and
select the at least one edge of the display screen along which to provide the edge light for a location of the edge light to correspond to the low light region of the face of the user.

13. The display-based illumination system of claim 1, wherein the one or more processors are configured to:
receive a command message generated by a user input device configured to be operated by the user; and
control the display device to modify at least one of (i) a size of the second area of the display screen that provides the edge light, (ii) a brightness of the edge light, or (iii) a color temperature of the edge light, based on the command message.

14. A method of illuminating a user of a computer device, the method comprising:
controlling a display device to display content to a user of the display device on a first area of a display screen of the display device;
controlling the display device to provide an edge light along a different, second area of the display screen by emitting a constant light from the second area for an extended period of time to illuminate the user of the display device; and
controlling the display device to restrict a cursor, for selectively interacting with the content displayed on the display screen, to the first area of the display screen by preventing the cursor from moving into the second area that provides the edge light.

15. The method of claim 14, wherein the display device is controlled to display the content to the user on the first area of the display screen, to provide the edge light on the second area of the display screen, and to restrict the cursor to the first area during an illumination mode of operation of the display device, wherein the method further comprises switching the display device between the illumination mode and a normal mode of operation in which the display device displays the content to the user on both the first and second areas of the display screen without providing the edge light.

16. The method of claim 15, further comprising scaling down a graphical user interface that is displayed on the display screen when switching from the normal mode of operation to the illumination mode of operation so that the graphical user interface is confined to the first area of the display screen when in the illumination mode.

17. The method of claim 15, further comprising:
analyzing image data depicting the user, the image data generated by a camera associated with the display device;
determining that the user is in a low light condition based on the image data; and
switching the display device from the normal mode to the illumination mode in response to determining that the user is in the low light condition.

18. The method of claim 14, wherein controlling the display device to provide the edge light along the second area comprises positioning the edge light to fully surround the first area of the display screen.

19. The method of claim 14, further comprising:
receiving a command message generated by a user input device configured to be operated by the user; and
controlling the display device to modify at least one of (i) a size of the second area of the display screen that provides the edge light, (ii) a brightness of the edge light, or (iii) a color temperature of the edge light based on the command message.

20. A computer program product comprising a non-transitory computer readable storage medium, the non-transitory computer readable storage medium comprising computer executable code configured to be executed by one or more processors to:
control a display device to display content to a user of the display device on a first area of a display screen of the display device;
control the display device to provide an edge light along a different, second area of the display screen by emitting a constant light from the second area for an extended period of time to illuminate the user of the display device; and
control the display device to restrict a cursor, for selectively interacting with the content displayed on the display screen, to the first area of the display screen by preventing the cursor from moving into the second area that provides the edge light.
